(19) United States
(12) Patent Application Publication
(10) Pub. No.: US 2013/0262211 A1
(43) Pub. Date: Oct. 3, 2013

(54) WEB-BASED, SELF-SERVICE COUPON CONTENT MANAGEMENT SYSTEM

(71) Applicant: COUPON FACTORY, LLC, Rogers, AR (US)

(72) Inventors: Kenny James Tomlin, JR., Rogers, AR (US); Wade R. Allen, Lantana, TX (US); Christopher Michael Baran, Rogers, AR (US); Justin Allen Bryant, McKinney, TX (US)

(73) Assignee: Coupon Factory, LLC, Rogers, AR (US)

(21) Appl. No.: 13/661,588

(22) Filed: Oct. 26, 2012

Related U.S. Application Data
(60) Provisional application No. 61/616,030, filed on Mar. 27, 2012.

(51) Int. Cl. G06Q 30/02

(52) U.S. Cl. 705/14.26

(57) ABSTRACT

Systems, methods and computer program products for securely printing coupon prints and for facilitating a digital couponing platform for creating, managing, and publishing digital coupon campaigns are disclosed. In an aspect, such digital couponing platform allows creators to market (i.e., create and publish) and review data related to promotional coupons, and consumers may request and print physical coupon prints. Consumers may request coupon prints via an application virtual machine (e.g., Java® applet) executing on an Internet-enabled computing device with several selected security features. In some aspects, coupon prints are printed by a consumer without presenting the consumer with a graphical representation of coupon print so that coupon print counterfeiting opportunities via utilization of screen capture software are reduced.

### CROSS REFERENCE TO RELATED APPLICATION

This application claims priority to U.S. Provisional Patent Application No. 61/616,030 (Atty. Docket No. 2036.01), filed on Mar. 27, 2012, which is hereby incorporated by reference in its entirety.

### FIELD OF THE INVENTION

The present disclosure generally relates to digital coupon platforms and more particularly to systems, methods, and computer program products for facilitating the creation, management, and printing of coupon prints by consumers.

### BACKGROUND

Technology surrounding the Internet continues to grow exponentially. With these technological advancements, the Internet has become a more efficient means to collect and distribute many types of information compared to physical platforms (e.g., newspaper listings, brochures, handouts containing printed coupons, and the like). For example, advertisements may be electronically produced and distributed to the public with greater ease and versatility compared to advertisements in traditional print media.

It is known that coupons are regularly issued in order to stimulate sales of goods or services. Coupons are tickets, documents, and other redeemable items exchanged for a financial discount and/or rebate in the purchase of a product or service during sales promotions. Coupons may be issued by manufacturers, retailers, resellers and other entities seeking to drive the sale of a good or service. Coupons may be distributed via a variety of channels including, but not limited to the mail, magazines, and newspapers.

The growth of the Internet and other mobile communications advances have spurred the distribution of coupons through mobile telephones and the Internet. That is, paper coupons have been the traditional method for distributing promotional materials, discounts, and/or rebates, but are experiencing steady decline. This decline was evidenced in 2010, when the digital coupon market grew by 41%, but the market growth for paper coupons was merely 7%. It has additionally been reported that in 2009, the number of American consumers receiving coupons from sources other than printed newspapers increased from 9.4 million to 13.2 million people, thus showing a trend away from printed media coupons. In fact, as of 2010, consumers have experienced a total nationwide savings of over US$1.2 billion through the use of digital coupons.

Another platform targeted by businesses for offering digital coupons is the mobile telephone. With over 5.2 billion subscribers (exceeding personal computer ownership 4.3 to 1), the mobile telephone industry is one of the largest industries in the world. The mobile telephone industry is also one of the fastest growing markets in the world. This size and growth provides an ever-increasing market and technological infrastructure for the distribution of promotional materials, including digital coupons and digital coupon offers. Systems that fluidly offer such materials on mobile telephones are needed to meet this manufacturer need.

In general, through the use of coupons, businesses seek an efficient manner to draw consumers toward purchase of their products and services, as well as collect and study related data for brand and distribution improvements.

With many web-based printable coupons and digital coupon applications, coupon issuers expose themselves to potential counterfeiting of coupon prints. Without a security system in place, it becomes easy for unscrupulous individuals to print duplicates of a coupon print and/or edit certain information contained therein to obtain otherwise unavailable promotions and discounts. Appropriate safeguards are needed to avoid this abuse and to ensure coupon issuers have access to complete data on the effectiveness of various marketing efforts.

Lastly, registering and downloading unwanted programs and applications every time a consumer wishes to take advantage of a digitally-delivered coupon offer is an unnecessary hurdle for many consumers. This hurdle has a great potential to deter consumers from finding coupons and, therefore, becoming aware of a business's brand, products and/or services. Additionally, coupon distribution venues are limited because of the rich system requirements for viewing certain advertising materials. Systems, methods, and computer program products are needed that provide a seamless couponing process and increase the number of different digital venues for potential coupon postings.

### SUMMARY

This Summary is provided to introduce a selection of concepts. These concepts are further described below in the Detailed Description. This Summary is not intended to identify key features or essential features of the disclosures subject matter, nor is this Summary intended as an aid in determining the scope of the disclosed subject matter.

Aspects of the present disclosure meet the above-identified needs by providing systems, methods, and computer program products for facilitating a digital couponing platform for creating, managing, and publishing digital coupons and securely printing coupon prints. Coupon prints are physical tickets, documents, and other redeemable items (including two-dimensional or three-dimensional items) which may be exchanged for an advertised offer.

Many digital couponing platforms, especially those platforms which require the consumer to download unwanted programs and applications in order to print a coupon print, frustrate many consumers. Such consumer frustration leads to high abandon rates (i.e., frequent occurrences where a consumer carries out some, but not all, of the steps necessary to select and print a coupon). Aspects of the present disclosure provide a simplified consumer experience which utilizes existing software on the consumer's computing device. By using existing software such as the Java® runtime/virtual machine (available from Oracle America, Inc. of Redwood Shores, Calif.), a free and versatile software package found on the vast majority of modern consumer computing devices, aspects of the present disclosure eliminate the irritation of downloading proprietary software and going through drawn out coupon selection and printing processes.

The coupon selection and printing process may be further simplified by presenting the consumer with a one click process for selection and printing of a coupon. Where an aspect of the present disclosure is deployed within a webpage (e.g., within a Java® applet on a social network page, on a portion of an email, and the like) it may be configured to allow the consumer to select and print a coupon without leaving the webpage. Eliminating the need to download proprietary coupon printing software and avoiding redirection of the consumer's web browser may substantially increase consumer conversion rates (i.e., the percentage of consumers who see a coupon promotion and complete the process of selecting and printing a coupon). Additionally, configuring an aspect of the present disclosure to operate within a portion of a webpage and eliminating the need to redirect the consumer enables smooth deployment without multiple locations such as social networking sites, brand product pages, online retailers, blogs, and other websites and digital destinations.

Aspects of the present disclosure facilitate quick, simple development and publishing of coupon campaigns. The present disclosure may provide a coupon campaign creator (e.g., a manufacturer, retailer, reseller, an entity seeking to drive the sale of a good or service, and the like) with a “What You See Is What You Get” (WYSIWYG) editor for creating and viewing coupon campaign details, coupon promotions, and coupon prints. The editor may allow the creator, via a customizable template, to upload product/service information and background images that match their brand and offer, set the offer text, set the expiration date of the offer, upload a previously-designed coupon, and/or provide additional relevant information.

In yet another aspect, the present disclosure provides a web banner editor for creating and distributing coupon promotions. Coupon promotions, such as web banners, may be configured to be selectable by a consumer. The coupon promotion may prompt the consumer to provide information the creator wishes to collect from the consumer before issuing a coupon print, such as physical address, phone number, email address, interest in a product, and the like. In such an aspect, a coupon promotion may be shared throughout various marketing channels (e.g., company websites, blog networks, media advertisement networks, affiliate networks, web channels, and the like). Such coupon promotions may serve as a banner advertisement on a blog, social networking site or other website, and may be available in a variety of sizes (e.g., a 300×250 pixel sized web banner). Additionally, such coupon promotions may be available via a mobile application or embedded as a listing on the creator's website or an affiliate website.

Collection and analysis of coupon-related metrics may assist a creator in determining whether a coupon campaign is a viable marketing effort compared to past coupon campaigns or other marketing efforts. Such analysis may also assist in planning brand and distribution choices and improvements. The present disclosure may provide a performance dashboard for viewing coupon campaign-related data and analysis in an easy-to-view format. Performance metrics related to such coupons may be tracked, recorded, and downloaded by the creator. The information to be tracked, recorded, and downloaded may include: impressions; clicks; prints; referring URLs; affiliate site traffic; leads (i.e., users opting to print the coupons); geography of leads; performance by brand and category; and the like.

Coupon campaign creators may wish to limit, at the individual consumer level or the campaign level, the number of coupon prints available. Creators may reduce fraudulent production and redemption of coupon prints by utilizing aspects of the present disclosure. Coupon prints may be printed without presenting the consumer with a graphical representation of the coupon print. By avoiding displaying the coupon print on the consumer's screen, creators eliminate an unscrupulous consumer's ability to take a screenshot of a displayed coupon print and produce more than their approved amount.

Other aspects of the present disclosure print coupon prints without utilizing local print software. Still other aspects first determine if a consumer specified printer is a valid device and may only print the coupon print if the consumer has specified a valid device, such as a physical printer.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for securely printing coupon prints and facilitating the operation of a digital couponing platform, according to an aspect of the present disclosure.

FIG. 2 is a block diagram of an exemplary system for facilitating publishing, selecting, printing, and redeeming coupon prints, according to an aspect of the present disclosure.

FIG. 3 is a flowchart of a process for facilitating the production of a coupon print, according to an aspect of the present disclosure.

FIG. 4 is a flowchart of a process for facilitating the production of a coupon print and for storing associated data, according to an aspect of the present disclosure.

FIG. 5 is a flowchart of a process for facilitating data analysis of digital couponing platform data, according to an aspect of the present disclosure.

FIG. 6 is a flowchart of a process for determining if a received coupon request may be allowed, according to an aspect of the present disclosure.

FIG. 7 is a flowchart of a process for determining if the consumer has specified a valid device for printing a coupon print, according to an aspect of the present disclosure.

FIG. 8 is a block diagram of an example computing system useful for implementing the present disclosure.

### DETAILED DESCRIPTION

The present disclosure is directed to systems, methods, and computer program products for facilitating a digital couponing platform for creating, managing, and publishing digital coupons and securely printing coupon prints.

Aspects of the present disclosure may be utilized to securely print, via a physical printer, one or more coupon prints requested by a consumer.

Coupon campaign creators are individuals, brand managers, agencies, content providers, companies, organizations, or other entities such as a manufacturer, retailer, restaurant, reseller, or any other entity seeking to drive the sale of a good or service on their own behalf or on another's behalf. Creators may utilize aspects of the present disclosure to produce coupons campaigns which offer various promotions to consumers via one or more marketing channels.

A coupon campaign is a marketing effort defined by the creator. It may comprise offer data and promotion data.

Offer data is information related to the product(s) or service(s) featured in the coupon campaign and the available pricing, discounts, or other offers associated with the product(s) or service(s). Offer data may include: references to a product or service; references to a class of products or services; specific product or service exclusions; a percentage discount; a dollar value discount; images of the product(s) or service(s); redemption instructions; terms and conditions; expiration dates; and other coupon offer-related information as will be appreciated by those skilled in the relevant art(s) after reading the description herein.

Promotion data is information related to the operation of the coupon campaign. Promotion data may include: coupon promotions, such as banner advertisements (described in more detail below); coupon campaign length; coupon campaign budget; number of coupon prints authorized to be created; number of coupon prints authorized to be redeemed (globally or per user); demographic information of target consumers; marketing channels to be used in the coupon campaign; coupon promotion impressions to be displayed; consumer clicks on coupon promotions permitted; and other coupon campaign-related information as will be appreciated by those skilled in the relevant art(s) after reading the description herein.

Creators may create one or more coupon campaigns, which may run concurrently or during different time periods.

A coupon promotion is a graphical, digital, audio, or other representation of the coupon campaign offer configured to apprise consumers of the coupon offer such that the consumer may request a coupon. Coupon promotions include banner advertisements, text listings, audio listings or other promotions.

Consumers may redeem the offers associated with a coupon campaign via coupon prints. Coupon prints are physical tickets (i.e., a “hard copy”), documents, and other redeemable items (including two-dimensional or three-dimensional items) which may be exchanged for the offer associated with the coupon campaign, according to the terms of the coupon campaign. Coupon prints may be produced by the consumer's hardware, such as the consumer's printer. Coupon prints may be produced by the consumer's printer via commands or print tokens generated in response to a valid print request received from the consumer.

The coupon print may consist of one or more of the following: unique coupon campaign identification information; coupon print identification information; coupon offer name; a headline; a description; product image; product thumbnail image; brand image; brand thumbnail image; brand text; redemption image (e.g., barcode, Universal Product Code (UPC, as defined by GS1, Association Internationale of Brussels, Belgium), GS1 DataBar® (available from GS1, Association Internationale of Brussels, Belgium), International Article Number (EAN-13) barcode (as defined by GS1, Association Internationale of Brussels, Belgium), and the like); background color; pin number; offer identification; headline color; and other portions as will be appreciated by those skilled in the relevant art(s) after reading the description herein. The preceding portions may be unique to the coupon print or may be uniform across all coupon prints associated with a coupon campaign.

In some aspects, the digital couponing platform may further comprise the following functionalities: the ability to show or hide security borders on a coupon print; the ability to show or hide unique identification stamped on the coupon print; the ability to automatically create a barcode for a coupon print (e.g., 128C barcode, GS1 DataBar®, and the like); set a shortened web Uniform Resource Locator (URL); setting coupon categorization; allocating coupon campaign inventory; allocating the number of individual printings per consumer; set a fixed or rolling expiration date; configuring the rolling expiration date; associating or specifying local or multiple locations where the coupon print may be redeemed; specifying coupon availability by geography; and/or targeting web banner, web listing, or mobile platforms for promotion.

In various aspects, such systems, methods, and computer program products provide several core coupon security features. Each coupon print may be stamped with a system generated unique identification and counterfeit deterrent image for the prevention of photocopying and other fraudulent activities. Further, in certain aspects, coupons are not displayed on a computing device screen, and may be only viewable via physical print.

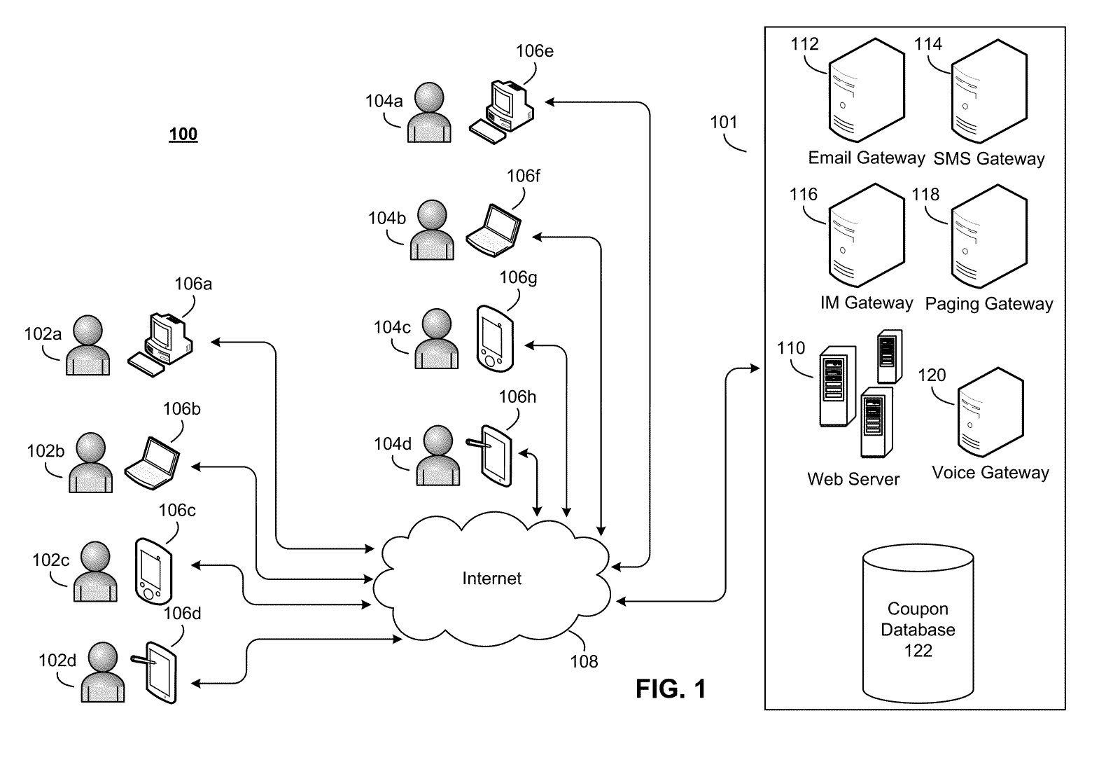

Referring now to FIG. 1, a block diagram of an exemplary system 100 for securely printing coupon prints and facilitating the operation of a digital couponing platform, according to an aspect of the present disclosure, is shown.

Cloud-based, Internet-enabled device communication system 100 includes a plurality of creators 102 (shown as creators 102a-d in FIG. 1) and consumers 104 (shown as consumers 104a-d in FIG. 1) accessing—via a computing device 106 (shown as respective computing devices 106a-h in FIG. 1) and a network 108, such as the global, public Internet—an application service provider's cloud-based, Internet-enabled infrastructure 101. In various aspects, computing device 106 may be configured as: a desktop computer 106a,e; a laptop computer 106b,f; a Personal Digital Assistant (PDA) or mobile telephone 106c,g; a tablet or mobile computer 106d,h; any commercially-available intelligent communications device; or the like. System 100 may further comprise printing devices such as inkjet, thermal, or laser printers (not shown in FIG. 1).

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, and a coupon database 122. Coupon database 122 may be configured to store coupon-related data, some of which is to be posted on one or more web-based channels (e.g., websites, blogs, social networking sites, media properties, digital loyalty programs, etc.). In alternate aspects, coupon database 122 may comprise one or more data stores within (or remotely located from) infrastructure 101 or be a memory included in (or coupled to) web server 110.

In an aspect of the present disclosure, coupon database 122 stores coupon-related data and facilitates validating the following: the coupon campaign is active and available for printing coupon prints; the current date is between the effective and expiration dates; the account distributing the coupon campaign is in good standing; there are sufficient coupon prints available in inventory; the print token is authentic; and/or the machine where the print is to occur has sufficient software and hardware requirements to perform the print (e.g., if the printer on the machine is configured to print to a Portable Document Format (PDF) writer and/or virtual printer), and if the computing device 106 or consumer 104 requesting the print has not exceeded a criterion, such as the print-per-consumer threshold limit set by creator 102.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable such that multiple creators 102 and consumers 104 may utilize it to facilitate the communication of select companies' coupon campaigns from coupon database 122 to computing devices 106.

As will also be appreciated by those skilled in the relevant art(s), in an aspect, various screens (e.g., login, admin, account, information, resource, logout, payment, coupon print editing, coupon promotion editing, coupon campaign editing, registration, printing, communications, and the like) would be generated by server 110 in response to input from creators 102 and consumers 104 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various creators 102 and consumers 104. Thus, server 110 is able to provide a GUI to creators 102 and consumers 104 of system 100 in the form of webpages. These webpages are sent to the creator's and consumer's PC, laptop, mobile device, PDA or the like device 106, and would result in the GUI being displayed.

As will be appreciated by those skilled in the relevant art(s) after reading the description herein, alternate aspects of the present disclosure may include providing a tool for facilitating the communication of coupon campaign-related information from coupon database 122 to devices 106 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where consumers 104 are all personnel/employees of the same company, the present disclosure may be implemented as a stand-alone system, rather than as a web service (i.e., Application Service Provider (ASP) model utilized by various users from different companies) as shown in FIG. 1.

As will also be appreciated by those skilled in the relevant art(s) after reading the description herein, alternate aspects of the present disclosure may include providing the tools for facilitating the communication of coupon campaign-related information from coupon database 122 to devices 106 via a browser pre-installed with an applet or a browser with a separately downloaded applet on such devices 106. That is, as will also be apparent to one skilled in the relevant art(s) after reading the description herein, the applet that facilitates the digital couponing platform disclosed herein and, in particular, the printing of coupon prints by devices 106 as described herein, may be part of the “standard” browser that ships with computing device 106 or may be later added to an existing browser as part of an “add-on” or “plug-in.”

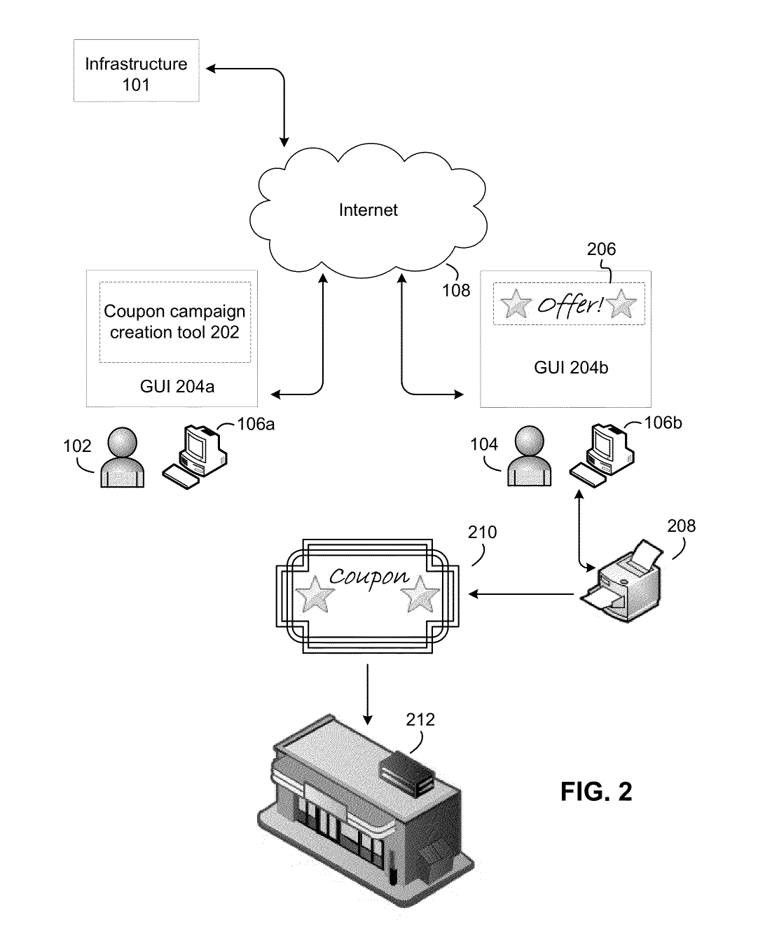

Referring now to FIG. 2, a block diagram of an exemplary system for facilitating publishing, selecting, printing, and redeeming a coupon print 210, according to an aspect of the present disclosure, is shown.

In an aspect, an application service provider's cloud-based, communications infrastructure 101 provides a coupon campaign creation tool 202 via Internet 108. Creation tool 202 may be presented to creator 102 via GUI 204a at device 106a.

Creation tool 202 may be configured to manage one or more coupon campaigns. Creation tool 202 may comprise a “What You See Is What You Get” (WYSIWYG) editor for inputting, creating and/or viewing coupon campaign details, coupon promotions 206, and coupon prints 210. The editor allows creators 102, via a customizable template, to upload offer data and promotion data including product/service and background images that match their brand and offer, to set the offer text, to set the expiration date of the offer, and/or upload a previously-designed coupon print or coupon promotion. Coupon promotion 206 depicted in FIG. 2 is a web banner.

Creation tool 202 may further comprise a WYSIWYG web banner editor or other coupon promotion editor for creating and distributing coupon promotions. Coupon promotions 206, such as web banners, may be configured to be selectable by consumer 104. Coupon promotion 206 may prompt consumer 104 to provide information creator 102 wishes to collect from consumer 104 before issuing coupon print 210, such as consumer address, phone number, email address, interest in a product, and the like. This information may be stored in infrastructure 101 or some other location for later access and analysis by creator 102 or a third party.

Coupon promotion 206 may be published via one or more marketing channels by being shared throughout various networks (e.g., company websites, blog networks, media advertisement networks, affiliate networks, web channels, and the like).

Marketing channels are the locations or manners in which coupon promotion 206 is delivered. Marketing channel examples include: email, API, ad networks, social networks, mobile listings, web banners, and mobile advertisements.

Coupon promotions 206 may be published as a banner advertisement on blog, social networking site or other website, and may be available in a variety of sizes (e.g., a 300×250 sized web banner). Coupon promotions 206 may be available via a mobile application or embedded as a listing on creator's 102 website or an affiliate website. Coupon promotions 206 may be included in an email sent directly to first consumer 104 by second consumer 104, creator 102, or a third party. As will be appreciated by those skilled in the relevant art(s) after reading the description herein, coupon promotions 206 may be configured for other digital or physical marketing channels and delivered to consumers via such marketing channels.

Coupon promotions 206 are presented to consumer 104 via GUI 204b at device 106b. Infrastructure 101 may receive, via Internet 108 a coupon request from consumer 104 via consumer's selection of coupon promotion 206. A print token authorizing the printing of coupon print 210 on consumer's physical device 208 may be sent via Internet 108 to device 106b. In some aspects, print command is sent directly to physical device 208. Physical device 208 is a device capable of producing coupon print 210, such as an inkjet, thermal, or laser printer.

As shown in FIG. 2, after printing coupon print 210 on physical device 208, consumer 104 may redeem the offer associated with coupon print 210 by taking coupon print 210 to the appropriate retailer location 212. Location 212 may be a consumer goods store, restaurant, content provider, organization or any other entity such as a manufacturer, retailer, restaurant, reseller, or some other entity seeking to drive the sale of a good or service on their own behalf or on another's behalf. In some aspects, creator 102 is associated with location 212 (e.g., employee, contractor, and the like). In other aspects, creator 102 is not associated with location 212.

Coupon prints 210 redeemed at location 212 may be tracked through a variety of means. The number of coupon prints 210 collected may be recorded. Identifying portions placed on coupon print 210 when coupon print 210 was printed such as coupon print identification information; redemption image; or other unique information encoded in a graphic (e.g., barcode, UPC code, GS1 DataBar®, International Article Number (EAN-13) barcode, and the like) may be recorded. Information recorded at redemption locations 212 may be given to the application service provider, reentered into environment 100, or input into programs created in accordance with this disclosure in order to compare redemption rates of coupon prints 210 with other portions of a coupon campaign.

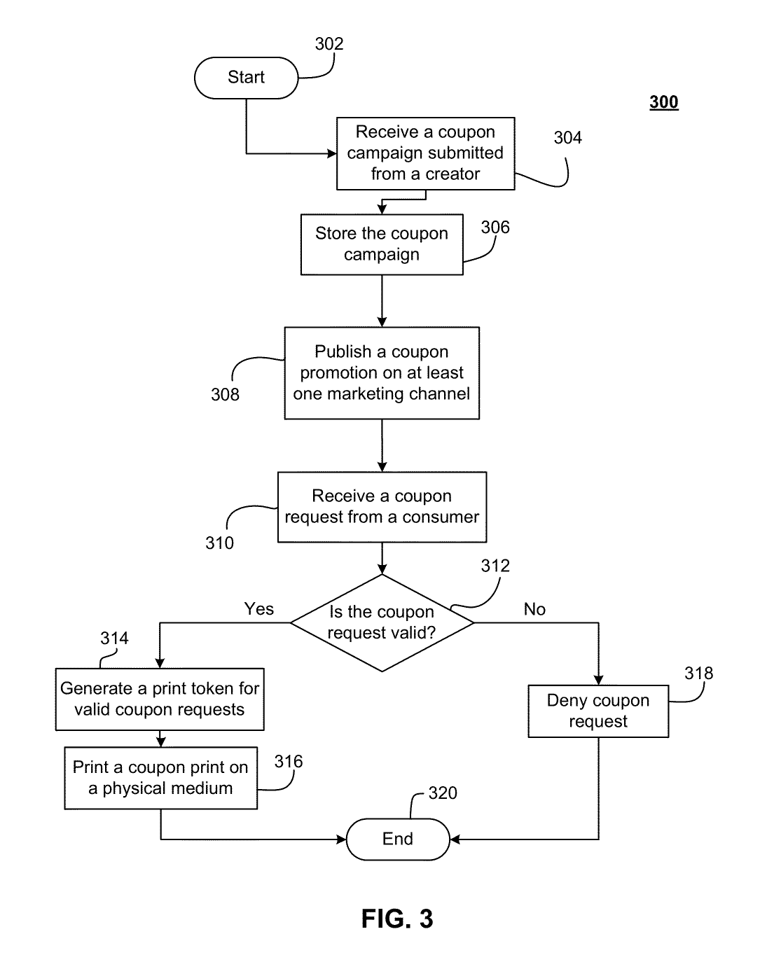

Referring now to FIG. 3, a flowchart of a process 300 for facilitating the production of coupon print 210, according to an aspect of the present disclosure, is shown.

Process 300, which may execute within environment 100 and facilitate the printing of coupon print 210 via creators 102 initiating a coupon campaign and consumer 104 requesting one or more coupon prints 210, begins at step 302 with control immediately passing to step 304.

Creator 102 creates a coupon campaign comprising offer data and promotion data in order to stimulate sales of goods and/or services. Coupon campaign may be created through the use of creation tool 202. In other aspects, a coupon campaign may be created via some other means as will be appreciated by those skilled in the relevant art(s) after reading the description herein.

In step 304, a coupon campaign is received from creator 102. In some aspects, portions of coupon campaign are submitted by creator 102 and other portions of the coupon campaign are provided by the application service provider. For example, the application service provider may supply templates for coupon promotions 206, advertising copy, or inventory levels for coupon prints 210 based on a coupon campaign budget set by creator 102.

In step 306, the coupon campaign information is stored in coupon database 122. In another aspect, the coupon campaign is stored in a separate database accessible via Internet 108. In yet another aspect, the coupon campaign is stored on a separate database and accessible by some other means.

In some aspects, the coupon campaign may be accessed and updated during the course of the coupon campaign in order to modify coupon campaign data, compare portions of coupon campaign to other portions of coupon campaign or to other data.

After the storage of the coupon campaign information coupon promotion 206 is published via at least one marketing channel, in step 308. Coupon promotion 206 may a banner advertisement, text listing, audio listing or other promotion. A marketing channel is the location or manner in which coupon promotion 206 is delivered. A marketing channel may be placing coupon promotion 206 on various networks (e.g., company websites, blog networks, media advertisement networks, affiliate networks, web channels, and the like). Email delivery may also be a marketing channel. Blogs, social networking sites, or other websites may also be used as marketing channels where creator 102, consumer 104, or a third party places coupon promotion 206 on such sites. Coupon promotions 206 may be placed where consumer 104 may be exposed to coupon promotion and interact with coupon promotion such that a coupon request may be created by such interaction and received.

Coupon promotion 206 may be presented to consumer 104 via the Java® runtime/virtual machine. In such an aspect, coupon promotion 206 may be a portion of a coupon applet. The Java® runtime/virtual machine may be pre-installed on consumers' computing devices 106. When the Java® runtime/virtual machine is not pre-installed on a consumer's computing device 106, it may be downloaded from a third party. In an aspect, consumer 104 may then be asked to accept the terms and conditions of the coupon applet. Once the terms and conditions of such applet are accepted, consumer 206 may then proceed with requesting and printing available coupon prints 210.

In step 310, a coupon request from consumer 104 is received. Consumer 104 may initiate one or more coupon requests by selecting a portion of coupon promotion 206 associated with an offer they are interested in and providing any required data, such as name, physical address, email address, and the like. An additional screen, such as a pop up, may be presented to consumer 104 in order to facilitate input and receiving of this information.

In step 312, received coupon requests are analyzed in order to determine if the coupon request is valid and may be acted upon. That is, the received coupon request is compared to coupon campaign data stored in coupon database 122. Coupon campaign may contain data specifying what information is required for a coupon request to be granted. For example, a coupon campaign may require consumer 104 to supply their name, age, phone number, and email address in order for the coupon request to be granted. Thus, if consumer 104 supplies, for example, only their name and phone number, their coupon request would be denied.

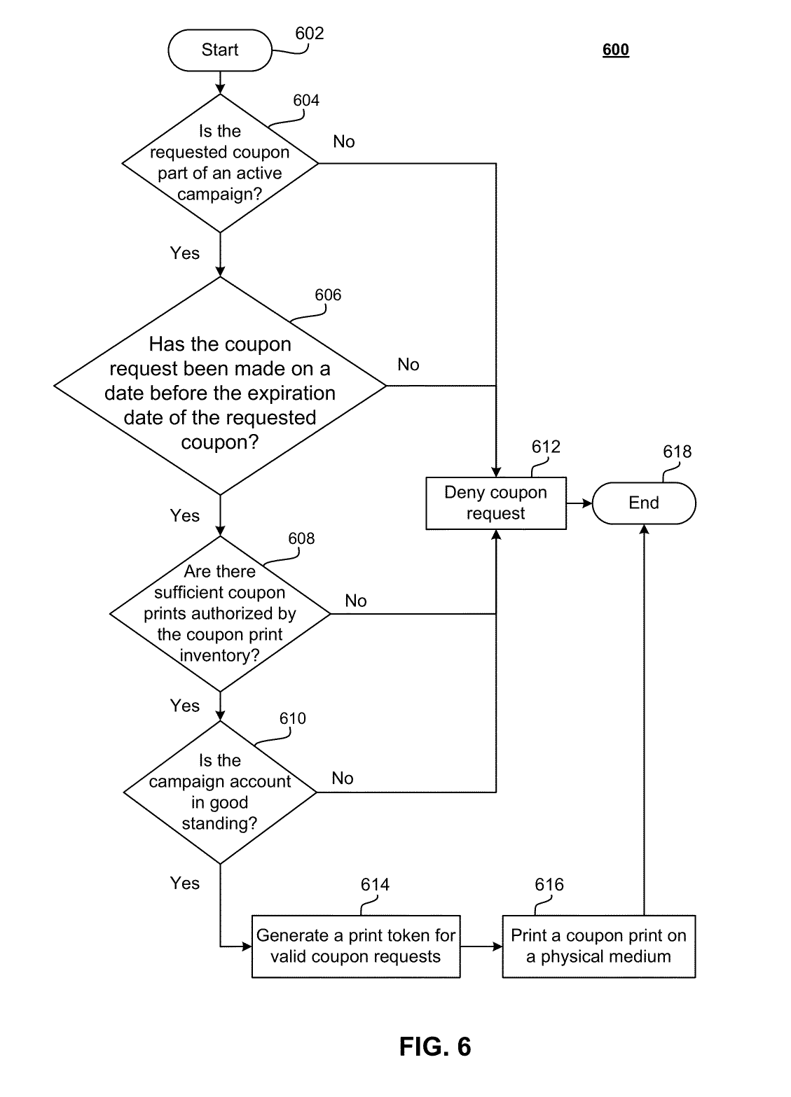

Coupon requests may also be denied where consumer 104 has supplied all the required information. For example, a coupon request may be denied because, although complete, the coupon request was received outside the active time window of the coupon campaign. Coupon requests may also be denied where the maximum number of coupon prints to be issued for a given coupon campaign has been met. Coupon requests may also be denied where consumer 104, the internet protocol (IP) address, the Media Access Control (MAC) address or some other identifier associated with the coupon request has exceed its print or request allotment. In such an aspect, the number of coupon prints 210 per consumer 104 or per household may be controlled by creator 102. As will be appreciated by those skilled in the relevant art(s) after reading the description herein, other criteria may be examined in order to determine if the coupon request should be granted. Further determining steps for granting a coupon request are enumerated below with respect to FIG. 6.

If the coupon request is found to be valid, step 314 and step 316 are executed.

In step 314, a print token is generated which authorizes the printing of a coupon print 210. In an aspect, the print token is sent to a coupon applet on consumer's device 106. The print token authorizes printer 208 to print one or more coupon prints 210 and may also include print instructions, including an image of coupon print 210. In another aspect, the print token is generated and permits printing instructions to be sent to printer 208.

In step 316, coupon print 210 is printed on a physical medium, resulting in a tangible object consumer 104 may utilize to redeem the associated offer. In an aspect, coupon promotion 206 is contained within a coupon applet or a webpage wherein a direct-to-printer capability is enabled on device 106 utilized by a consumer or separately downloaded. Direct-to-printer capability may be enabled in the web browser or in some other portion of device 106.

In another aspect, the direct-to-printer capability is then engaged, requesting a print token for security purposes. Such applet performs a print security check against the print token and data associated with device 208 (e.g., printer 208 or device 106 Media Access Control (MAC) address) in order to determine if device 106 is permitted to print coupon print 210.

If device 106 passes the print security check, then a coupon print 210 is printed. Process 300 then terminates at step 320.

In an aspect, after coupon print 210 is produced, the print token expires.

In another aspect, coupon print 210 is printed without presenting consumer 104 with a graphical representation of coupon print 210 so that coupon print 210 counterfeiting opportunities via utilization of screen capture software are reduced.

If, in step 312, the coupon request is found to be invalid, step 318 executes in lieu of step 314 and step 316.

In step 318, an invalid coupon request is denied. In an aspect, consumer 104 is notified of this denial via a graphical, audio, or audiovisual presentation. In another aspect, the coupon request denial is stored in a storage location, such as a database. Process 300 then terminates at step 320.

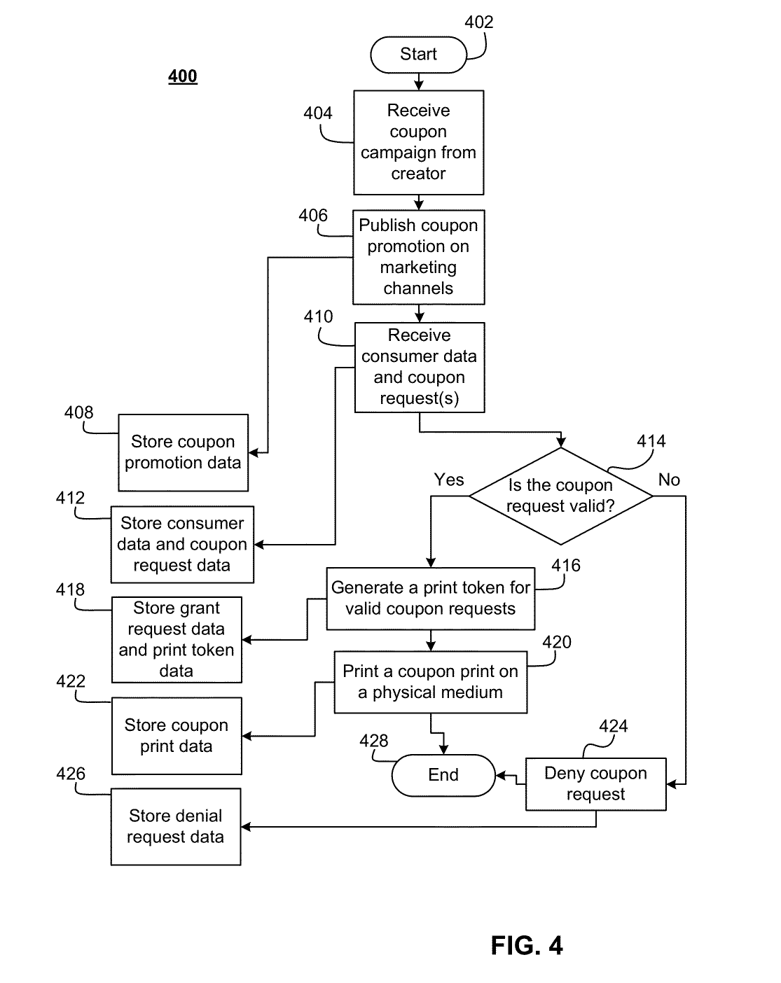

Referring now to FIG. 4, a flowchart of a process 400 for facilitating the production of coupon print 210 and for storing associated data, according to an aspect of the present disclosure, is shown.

Process 400, which may execute within environment 100 and facilitate the printing of coupon print 210 via creators 102 initiating a coupon campaign and consumer 104 requesting one or more coupon prints 210, begins at step 402. Control immediately passes to step 404.

In step 404, a coupon campaign is received from creator 102. In some aspects, portions of coupon campaign are submitted by creator 102 and other portions of the coupon campaign are provided by the application service provider.

The coupon campaign and other data generated during process 400 may be stored in a storage location, such as coupon database 122. In another aspect, the storage location is a database accessible via Internet 108. In yet another aspect, the storage location is a database and accessible by some other means.

Upon storage of the coupon campaign information, coupon promotion 206 is published via at least one marketing channel in step 406. Coupon promotion 206 may a banner advertisement, text listing, audio listing or other promotion.

Coupon promotion 206 may be presented to consumer 104 via the Java® runtime/virtual machine. In such an aspect, coupon promotion 206 may be a portion of a coupon applet.

In step 408, coupon promotion data is stored. Coupon promotion data comprises: coupon promotion 206 designs; information regarding marketing channels coupon promotion 206 is published on; the number of coupon promotion impressions displayed; and the like. Coupon promotion data may be stored in a storage location and accessible via Internet 108.

In step 410, a coupon request from consumer 104 is received. Consumer 104 may initiate one or more coupon requests by selecting a portion of coupon promotion 206 associated with an offer they are interested in and providing any required data, such as name, address, email address, and the like. An additional screen, such as a pop up, may be presented to consumer 104 on device 106 in order to facilitate input and receiving of this information.

In step 412, coupon request and consumer data are stored. Coupon request data comprises: coupon promotion 206 clicks; clicks per marketing channel; and the like. Consumer data comprises information a coupon campaign requires consumer 104 submit along with the coupon request, including: consumer name; address; phone number; occupation; email address; and the like. Coupon request data and consumer data may be stored in a storage location and accessible via Internet 108 or some other means.

In step 414, received coupon requests are analyzed in order to determine if the coupon request is valid and may be acted upon. The received coupon request is compared to coupon campaign data. The coupon campaign may contain data specifying what information is required for a coupon request to be granted.

If the coupon request is found to be valid, process 400 proceeds to step 416.

In step 416, a print token is generated which authorizes the printing of a coupon print 210. In an aspect, the print token is sent to a coupon applet executing on device 106. The print token authorizes printer 208 to print one or more coupon prints 210.

In step 418, coupon request grant data and print token data are stored. Coupon request grant data is information related to the analysis and approval of a coupon request. Print token data is information related to the print token which was generated including where the print token was sent and any unique identifying information generated for the print token. Coupon request grant data and print token data may be stored in a storage location and accessible via Internet 108 or some other means.

In step 420, coupon print 210 is printed on a physical medium, resulting in a tangible object consumer 104 may utilize to redeem the relevant associated offer. In an aspect, after coupon print 210 is produced, print token expires.

In step 422, coupon print data is stored. Coupon print data is information related to the coupon prints 210 that have been physically printed out and may comprise: coupon print image; coupon print security borders; barcodes; identifying numbers; identifying codes; and the like. Coupon print data may be stored in a storage location and accessible via Internet 108 or some other means.

Process 400 then terminates at step 428.

If, in step 414, the coupon request is found to be invalid, process 400 proceeds to step 424.

In step 424, an invalid coupon request is denied. In an aspect, consumer 104 is notified of this denial via a graphical, audio, or audiovisual presentation.

In step 426, coupon request denial data is stored. Coupon request denial data is information related to the analysis and approval of a coupon request.

Process 400 then terminates at step 428.

In another aspect, the present disclosure provides a performance dashboard for creators 102 to view statistics in an easy-to-view format. Such performance dashboard displays real-time analytics of creator 102 and consumer 104 activity over time, converts performance data for the creator 102 to download into a comma separated values (CSV) format for easy importation into databases or spreadsheets (e.g., the Microsoft Excel® spreadsheet database available from Microsoft Corporation of Redmond, Wash.), and presents other useful statistical data. Performance metrics related to such coupon campaigns, coupon promotions 206, and coupon prints 210 may be tracked, recorded, and downloaded by creator 102. The information tracked, recorded, and downloaded may include: impressions; clicks; prints; referring URLs; affiliate site traffic; leads; geography of leads; and/or performance by brand and category.

In such an aspect, coupon promotions 206 may be embedded with a one pixel image with a respective unique web URL for tracking web banners, web listings, and coupon prints 210. Each individual post contains a query string with information consisting of: coupon identification; date; site domain; URL; and/or affiliate URL. Such query string is then parsed and the respective facts are stored in a database management system (e.g., a NoSQL RDBMS).

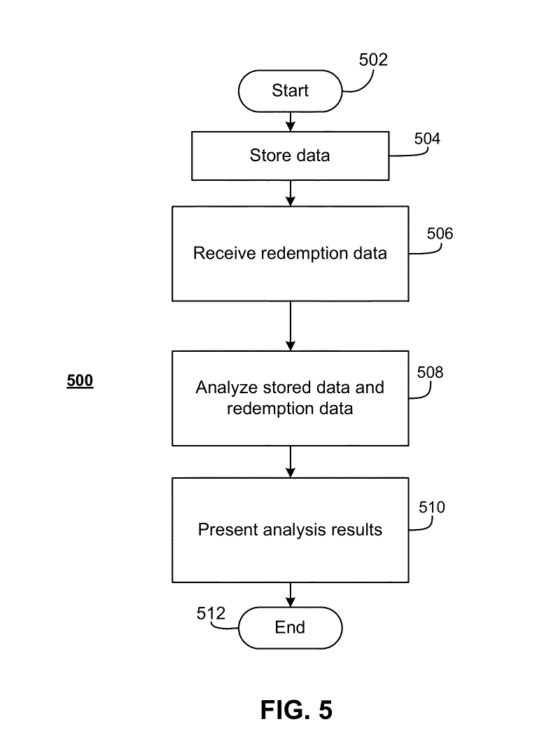

Referring now to FIG. 5, a flowchart of process 500 for facilitating data analysis of digital couponing platform data, according to an aspect of the present disclosure, is shown.

Process 500, which may execute within environment 100 and facilitate analysis of data associated with one or more coupon campaigns, begins at step 502 with control passing immediately to step 504.

In step 504, data generated during the operation of a digital couponing platform is stored. In an aspect, the data is stored at a storage location. A storage location may comprise one or more databases, including coupon database 122. Data stored may include data collected during process 400.

In step 506, coupon print redemption data is received. Redemption data is information collected about redeemed coupon prints 210 at redemption locations 212. Redemption data may, for example, be received by the application service provider or reentered into environment 100.

In step 508, stored data and redemption data are analyzed. Stored data may be compared to other stored data or stored data may be compared to received redemption data. This analysis may be done in any manner which will generate coupon related metrics to assist creators 102 or third parties in determining whether a coupon campaign is a viable marketing effort compared to past coupon campaigns or other marketing efforts. Such analysis may also assist in planning brand and distribution choices and improvements.

In step 510, the analysis results of step 508 are presented to the user (i.e., a creator 102) via production of a database, audiovisual means, or graphical means. Process 500 then terminates at step 512.

Referring now to FIG. 6, a flowchart of a process 600 for determining if a received coupon request may be allowed, according to an aspect of the present disclosure, is shown.

Process 600, which would execute within environment 100 and facilitate printing of coupon print 210, begins at step 602 with control passing immediately to step 604.

In step 604, coupon campaign data is compared to the received coupon request in order to determine if the requested coupon print is part of an active coupon campaign. An active coupon campaign is a coupon campaign which may currently cause the printing of coupon prints 210.

If the determination of step 604 is negative, the coupon request is denied in step 612. Process 600 then terminates at step 618. Otherwise, process 600 proceeds to step 606.

In step 606, coupon campaign data is compared to the received coupon request in order to determine if the coupon request was made on a date before the expiration date of the requested coupon print 210.

If the coupon request was made after the expiration date of the requested coupon print 210, the coupon request is denied in step 612. Process 600 then terminates at step 618. Otherwise, process 600 proceeds to step 608.

In step 608, coupon campaign data is compared to the received coupon request in order to determine if there are sufficient coupon prints 210 authorized by a coupon print inventory to approve the coupon request. The coupon campaign may further comprise a coupon print inventory, specified by a creator 102, indicating the number of coupon prints 210 which may be printed by consumers 104 for a given coupon campaign. If coupon print inventory levels are insufficient, the coupon request is denied in step 612. Process 600 then terminates at step 618. Otherwise, process 600 proceeds to step 610.

In step 610, coupon campaign data is compared to the received coupon request in order to determine if the coupon campaign is currently in good standing. A coupon campaign may not me in good standing if it is, for example, inactive, its creator 102 has not paid associated fees, or some other administrative reason.

If the coupon campaign is not in good standing, the coupon request is denied in step 612. Process 600 then terminates at step 618. Otherwise, process 600 proceeds to step 614 where a print token is generated and a coupon print 210 is printed on a physical medium, such as paper, in step 616. Process 600 then terminates at step 618.

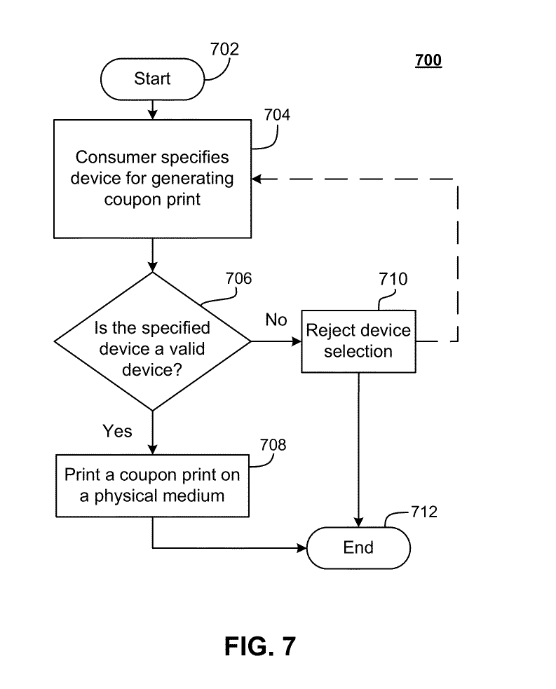

Referring now to FIG. 7, a flowchart of a process 700 for determining if the consumer has specified a valid device for printing a coupon print, according to an aspect of the present disclosure, is shown.

Process 700, which may execute within environment 100 and facilitate printing of coupon print 210 on a valid device, begins at step 702 with control passing immediately to step 704.

In step 704, consumer 104 specifies a device, such as printer 208, for printing coupon print 210. Consumer selection of a device may be facilitated by presenting consumer 104 with a list of devices within an applet or webpage displayed on device 106. In another aspect, the native applications for printing on consumer's device 106 facilitate consumer 104 selection of a device.

In step 706, the specified device is analyzed in order to determine if it is a valid device. A valid device is a device which is capable of generating a physical coupon print 210, such as an inkjet, thermal, laser, or 3D printer. Invalid devices include virtual printers and PDF printers, which are incapable of generating a physical coupon print 210.

If the specified device is not a valid device, consumer's device selection is rejected in step 710. Rejection may occur via a graphical, audio, or audiovisual presentation. Optionally, consumer 104 may be prompted to supply another device selection, returning to step 704. If consumer is not prompted to select another device, process ends at step 710.

If the specified device is a valid device, a coupon print 210 is printed in step 708. Process 700 then terminates at step 712.

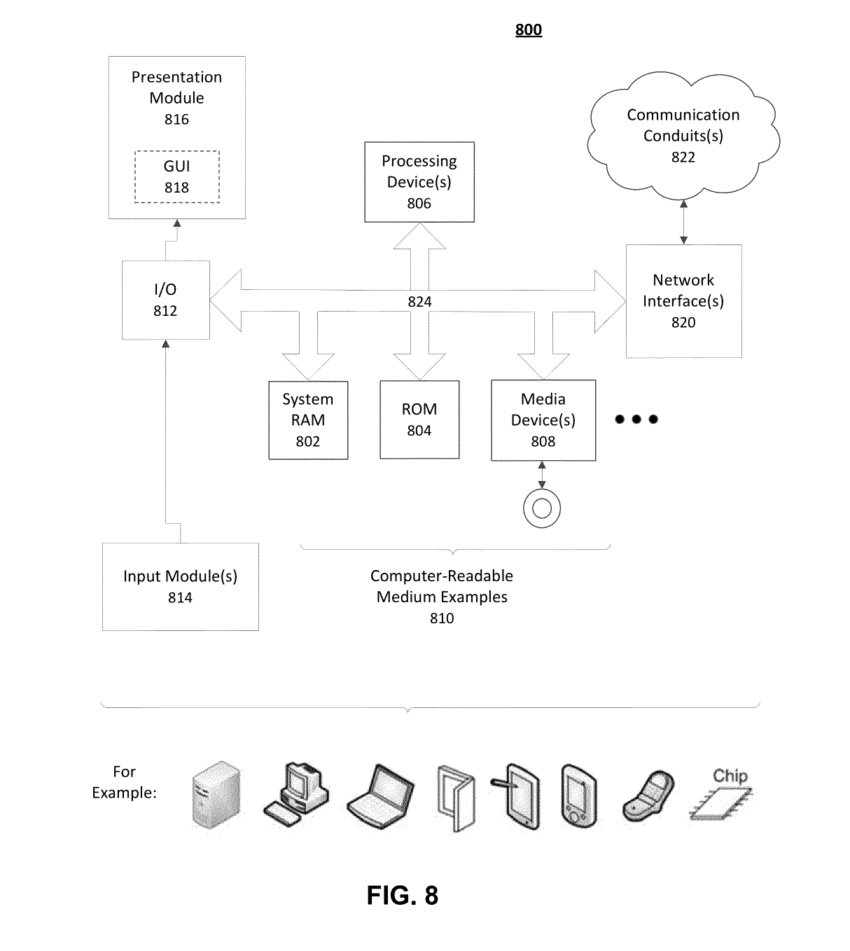

Referring now to FIG. 8, a block diagram of an exemplary computer system useful for implementing various aspects of the digital couponing platform for creating, managing, and measuring digital coupons, in accordance with one or more aspects of the present disclosure, is shown. FIG. 8 sets forth illustrative computing functionality 800 that may be used to implement web server 810, devices 806 utilized by creators 102 and consumers 104 to access Internet 108, or any other (digital couponing platform) component of environment 100. In all cases, computing functionality 800 represents one or more physical and tangible processing mechanisms.

Computing functionality 800 may comprise volatile and non-volatile memory, such as RAM 802 and ROM 804, as well as one or more processing devices 806 (e.g., one or more central processing units (CPUs), one or more graphical processing units (GPUs), and the like). Computing functionality 800 also optionally comprises various media devices 808, such as a hard disk module, an optical disk module, and so forth. Computing functionality 800 may perform various operations identified above when the processing device(s) 806 executes instructions that are maintained by memory (e.g., RAM 802, ROM 804, and the like).

More generally, instructions and other information may be stored on any computer readable medium 810, including, but not limited to, static memory storage devices, magnetic storage devices, and optical storage devices. The term “computer readable medium” also encompasses plural storage devices. In all cases, computer readable medium 810 represents some form of physical and tangible entity. By way of example, and not limitation, computer readable medium 810 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 802, ROM 804, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 800 may also comprise an input/output module 812 for receiving various inputs (via input modules 814), and for providing various outputs (via one or more output modules). One particular output mechanism may be a presentation module 816 and an associated GUI 818. Computing functionality 800 may also include one or more network interfaces 820 for exchanging data with other devices via one or more communication conduits 822. In some aspects, one or more communication buses 824 communicatively couple the above-described components together.

Communication conduit(s) 822 may be implemented in any manner (e.g., by a local area network, a wide area network (e.g., the Internet), and the like, or any combination thereof). Communication conduit(s) 822 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices, as described with reference to FIG. 8. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail may be made therein without departing from the spirit and scope of the present disclosure. Thus, the present disclosure should not be limited by any of the above described aspects.

In addition, it should be understood that the accompanying figures, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein).

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating the operation of a digital couponing platform, the method comprising the steps of:
(a) receiving, from a creator, a coupon campaign, the coupon campaign comprising:
offer data; and
promotion data;
(b) storing the coupon campaign in a database;
(c) publishing a coupon promotion on at least one marketing channel;
wherein the coupon promotion is based upon the coupon campaign; and
wherein the coupon promotion is configured to receive requests for coupons from at least one consumer interfacing with the at least one marketing channel;
(d) receiving from the at least one consumer, via the at least one marketing channel, a coupon request in response to the coupon promotion;
(e) determining if the coupon request is permitted by comparing the coupon request to at least a portion of the coupon campaign stored in the database; and
(f) when the determining step (e) is positive:
generating a print token;
wherein the print token allows a computing device utilized by the at least one consumer to print a coupon print onto a physical medium; and
(g) when the determining step (e) is negative:
generating a coupon request denial.

2. The method of claim 1, the method further comprising the step of:
(h) receiving coupon print redemption data;
wherein the coupon print redemption data is information related to the usage of at least one coupon print by at least one consumer.

3. The method of claim 2, the method further comprising the steps of:
(i) storing at least one of:
coupon request data;
coupon print token generation data;
coupon print data;
coupon request denial data; and
promotion data;
wherein promotion data comprises information related to published coupon promotions;
(j) analyzing at least one of:
coupon print redemption data;
stored coupon request data;
stored coupon print token generation data;
stored coupon print data;
stored request denial data;
stored promotion data; and
at least a portion of the coupon campaign;
with at least one of:
coupon print redemption data;
stored coupon request data;
stored coupon print token generation data;
stored coupon print data;
stored request denial data;
stored promotion data; and
at least a portion of the coupon campaign; and
(k) presenting the results of analysis step (j).

4. The method of claim 3, wherein the results of analysis step (j) are presented to the creator.

5. The method of claim 1, wherein the coupon campaign comprises:
an expiration date;
a coupon print inventory;
wherein the coupon print inventory is the number of coupon prints permitted to be printed for the coupon campaign;
campaign active status; and
campaign account standing; and wherein
the determining step (e) further comprises the steps of:
(l) validating the requested coupon is part of an active coupon campaign;
(m) validating the coupon request was made on a date before the expiration date of the requested coupon;
(n) validating there are sufficient coupon prints available in the coupon print inventory to fulfill the coupon request; and
(o) validating the campaign account is in good standing.

6. The method of claim 1, wherein the consumer specifies a device used to print the coupon print, the method further comprising the step of:
(p) determining if the consumer specified device is a valid device for printing the coupon print.

7. The method of claim 6, wherein a valid device is a physical printer.

8. The method of claim 7, wherein a physical printer is one of: an inkjet printer, a thermal printer, a laser printer, and a 3D printer.

9. The method of claim 6, wherein determining step (p) is negative when the consumer specifies a virtual printer.

10. The method of claim 1, wherein the coupon print is printed without presenting the consumer with a graphical representation of the coupon print.

11. The method of claim 1, the method further comprising the step of:
(h) when the determining step (e) is negative:
sending an indication to the at least one consumer that the coupon request is denied.

12. The method of claim 1, wherein at least one consumer interfaces with the marketing channel via a computing device and the computing device is chosen from the group consisting of: a desktop computer; a laptop computer; a PDA; a mobile telephone; a tablet computer; and a mobile computer.

13. The method of claim 1, wherein the computing device utilized by the at least one consumer to print a coupon print is one of: a desktop computer; a laptop computer; a PDA; a mobile telephone; a tablet computer; and a mobile computer.

14. The method of claim 1, wherein the at least one marketing channel is one of: a Java® applet, an email message, an API, an ad network, a social network, a mobile listing, a web banner, and a mobile advertisement.

15. The method of claim 14, wherein the at least one marketing channel is a Java® applet and the coupon request is received via the Java® applet.

16. The method of claim 1, wherein the coupon request comprises at least one of:
consumer name;
physical address;
phone number; and
email address.

17. A computer-implemented method for facilitating the operation of a digital couponing platform, the method comprising the steps of:
(a) receiving, from a creator, a coupon campaign, the coupon campaign comprising:
offer data; and
promotion data;
(b) storing the coupon campaign in a database;
(c) publishing a coupon promotion on at least one marketing channel;
wherein the coupon promotion is based upon the coupon campaign;
(d) receiving from the at least one consumer, a coupon request;
(e) determining if the coupon request is permitted by comparing the coupon request to at least a portion of the coupon campaign stored in the database; and
(f) when the determining step (e) is positive:
generating a print token;
wherein the print token allows a computing device utilized by the at least one consumer to print a coupon print onto a physical medium; and
(g) when the determining step (e) is negative:
generating a coupon request denial.

18. A computer readable storage medium for storing computer readable instructions, the computer readable instructions facilitating operation of a digital couponing platform, the computer readable instructions comprising:
logic configured to receive, from a creator, a coupon campaign, the coupon campaign comprising:
offer data; and,
promotion data;
logic configured to store the coupon campaign in a database;
logic configured to publish a coupon promotion on at least one marketing channel;
wherein the coupon promotion is based upon the coupon campaign; and
wherein the coupon promotion is configured to receive requests for coupons from at least one consumer interfacing with the at least one marketing channel;
logic configured to receive from the consumer, via the at least one marketing channel, a coupon request in response to the coupon promotion;
logic configured to determine if the coupon request is permitted by comparing the coupon request to at least a portion of the coupon campaign stored in the database;
logic configured to generate a print token when the received coupon request is permitted;
wherein the print token allows a computing device utilized by the at least one consumer to print a coupon print onto a physical medium; and
logic configured to generate a coupon request denial when the received coupon request is not permitted.

19. The computer readable storage medium of claim 18, wherein the coupon campaign comprises:
an expiration date;
a coupon print inventory;
wherein the coupon print inventory is the number of coupon prints permitted to be printed for the coupon campaign;
campaign active status; and
campaign account standing;
the computer readable storage medium further comprising:
logic configured to validate the requested coupon is part of an active coupon campaign;
logic configured to validate the coupon request was made on a date before the expiration date of the requested coupon;
logic configured to validate there are sufficient coupon prints available in the coupon print inventory to fulfill the coupon request; and
logic configured to validate the campaign account is in good standing.

20. The computer readable storage medium of claim 18, wherein the consumer specifies a device used to print the coupon print, the computer readable storage medium further comprising:
logic configured to determine if the consumer specified device is a valid device for printing the coupon print.

21. The computer readable storage medium of claim 18, wherein the coupon print is printed without presenting the consumer with a graphical representation of the coupon print.

22. A computer system for facilitating the operation of a digital couponing platform, comprising:
(a) means for receiving, from a creator, a coupon campaign, the coupon campaign comprising:
offer data; and,
promotion data;
(b) means for storing the coupon campaign in a database;
(c) means for publishing a coupon promotion on at least one marketing channel;
wherein the coupon promotion is based upon the coupon campaign; and
wherein the coupon promotion is configured to receive requests for coupons from at least one consumer interfacing with the at least one marketing channel;
(d) means for receiving, from the consumer, via the at least one marketing channel, a coupon request in response to the coupon promotion;
(e) means for determining if the coupon request is permitted by comparing the coupon request to at least a portion of the coupon campaign stored in the database;
means for generating a print token when the received coupon request is permitted;
wherein the print token allows a computing device utilized by the at least one consumer to print a coupon print onto a physical medium; and
(f) means for generating a coupon request denial when the received coupon request is not permitted.

23. The computer system of claim 22, wherein the coupon campaign comprises:
an expiration date,
a coupon print inventory,
wherein the coupon print inventory is the number of coupon prints permitted to be printed for the coupon campaign;
campaign active status, and
campaign account standing;
the determination (f) further comprising:
(g) means for validating the requested coupon is part of an active coupon campaign;
(h) means for validating the coupon request was made on a date before the expiration date of the requested coupon;
(i) means for validating there are sufficient coupon prints available in the coupon print inventory to fulfill the coupon request; and,
(j) means for validating the campaign account is in good standing.

24. The computer system of claim 22, wherein the consumer specifies a device used to generate the coupon print, the computer system further comprising:
(k) means for determining if the consumer specified device is a valid device for printing the coupon print.

25. The computer system of claim 22, wherein the coupon print is printed without presenting the consumer with a graphical representation of the coupon print.
